(19) United States
(12) Patent Application Publication
(10) Pub. No.: US 2020/0173789 A1
(43) Pub. Date: Jun. 4, 2020

(54) SYSTEMS AND METHODS OF ROUTING OPTIMIZATION

(71) Applicant: TerriTool, LLC, Newport Beach, CA (US)

(72) Inventors: Spencer Kern Kelleher, Newport Beach, CA (US); Anuj Sahni, Auckland (NZ)

(21) Appl. No.: 16/209,927

(22) Filed: Dec. 4, 2018

(51) Int. Cl. G01C 21/34; G06F 16/28; H04W 4/024

(52) U.S. Cl. CPC G01C 21/343; G01C 21/3476; H04W 4/024; G06F 16/285; G01C 21/3446

(57) ABSTRACT

Systems and methods of generating optimized routes that pass through any number of locations are disclosed in this application. Locations can be sent from a client to a web-service that processes those locations to create an optimized route. Locations are clustered into groups based on geographic proximity to one another before being linked together. Then, intra-cluster routes are developed that pass through each of the locations in each cluster. Intra-cluster routes start and stop where linkages connect different clusters together, or, if there is no linkage to start or stop at, the start and stop points can be determined by other means (e.g., route optimization). A proposed route can then be iteratively improved upon until a finalized route is created. Once a finalized route is created, a notification can be sent to a client so that the client can access the finalized route.

### FIELD OF THE INVENTION

The field of the invention is routing and route optimization. Systems and methods of computing a desired path among numerous locations. Embodiments enable efficient computations among a greater number of locations than before on existing hardware, and computing paths remotely saves battery life on mobile devices and enables faster computation through use of more powerful, remote hardware.

### BACKGROUND

The background description includes information that may be useful in understanding the present invention. It is not an admission that any of the information provided in this application is prior art or relevant to the presently claimed invention, or that any publication specifically or implicitly referenced is prior art.

Many professions require individuals to travel to many different locations in the course of carrying out a job. For example, delivery drivers and traveling sales representatives must visit as many locations as possible in a given amount of time, as efficiently as possible. Modern outside sales reps have access to boundless amounts of data for a given sales territory, but the question remains: how can that information be leveraged most effectively to improve sales numbers?

To enable individuals to visit as many locations as possible in a given amount of time, location information can be used to generate an optimized route that passes through each location that must be visited. Efforts to create systems and methods to solve this problem in the past have fallen short because they have failed to consider how routing can be accomplished more efficiently. Thus, it would be advantageous to have a route optimization platform that can automatically and efficiently develop routes that pass through a theoretically unlimited number of locations.

For such a system to efficiently incorporate a large number of locations into a route, it would be advantageous to create “clusters” of locations, where each cluster has its own intra-cluster route that can individually be optimized. This can result in a faster, more efficient optimization process for a route overall and make it possible to create routes that pass through any number of locations. Thus, it has yet to be appreciated that route optimization can be improved upon by changing the way routes are generated from what is commonly understood to be the best way to generate routes that include any number of locations.

### SUMMARY OF THE INVENTION

The present invention provides apparatuses, systems, and methods of offloading route optimization to a server. In one aspect of the inventive subject matter, a system for creating optimized routes is contemplated. The system includes a server configured to: receive a route request from a client computing, the route request comprising a set of locations, wherein each location of the set comprises location geolocation information; group the set of locations into at least a first cluster comprising at least a first location, a second cluster comprising at least a second location and a third location, and a third cluster comprising at least a fourth location; determine a cluster sequence; determine a first shortest distance between the first cluster and the second cluster and a second shortest distances between the second cluster and the third cluster, wherein the first shortest distance comprises the first location and the second location and the second shortest distance comprises third location and the fourth location; upon determining the first shortest distance and the second shortest distance, determine a first intra-cluster route for the first cluster, a second intra-cluster route for the second cluster, and a third intra-cluster route for the third cluster, wherein the first intra-cluster route ends at the first location, the second intra-cluster route begins at the second location and ends at the third location, and the third intra-cluster route begins at the third location; determine a starting location for the first intra-cluster route; assemble the first, second, and third intra-cluster routes, the first shortest distance, and the second shortest distance into a proposed final route; apply a set of human-defined fitness parameters to the proposed final route to determine a corresponding set of fitness parameter values; iteratively determine the set of fitness parameter values on subsequent proposed final routes to converge on a final route; and send, to the client, a route response comprising the final route.

In some embodiments, the server is further configured to receive a start point from the client, the start point comprising geolocation information, and the first intra-cluster route can start at a location associated with the start point. It is also contemplated that the start location of the client can include a current client location. The start location of the client comprises a desired start location. In some embodiments, each intra-cluster route connects all locations within each cluster. In some embodiments, the server is configured to group the set of locations according to DBSCAN.

In another aspect of the inventive subject matter, a system for creating optimized routes is contemplated. The system includes a server configured to: receive a route request from a client, the route request comprising a set of at least three locations, wherein each of the at least three locations comprises geolocation information, and wherein one of the at least three locations corresponds to a client-designated start point location; conduct an AI-based clustering process on the set of locations, thereby grouping the set of the at least three locations into a set of clusters comprising at least two clusters, the first cluster comprising a first location and the second cluster comprising a second location and a third location; determine a cluster sequence based on the client-designated start location; determine a shortest distance between the first cluster and the second cluster, the shortest distance comprising a distance between the first location and the second location; upon determining the shortest distance, determine an intra-cluster route for the second cluster; determine, based on the client-designated start location, a starting location for a proposed final route; determine the proposed final route based on the client-designated start location, the shortest distance between the first location from the first cluster and the second location from the second cluster, and the intra-cluster route for the second cluster; and send, to the client, a route response comprising the proposed final route.

In some embodiments, the start location of the client comprises a current client location. the start location of the client comprises a desired start location. It is contemplated that each intra-cluster route connects all locations within each cluster. In some embodiments, the server is further configured to: determine a second shortest distance between a third location from the second cluster and a fourth location from a third cluster; upon determining the second shortest distance, determine a third intra-cluster route for the third cluster; and assemble into a proposed final route (a) the first, second, and third intra-cluster routes, (b) the shortest distant between the first location and the second location, and (c) the second shortest distance.

In some embodiments, the server can also be further configured to: apply a set of human-defined fitness parameters to the proposed final route to determine a corresponding set of fitness parameter values; and iteratively determine the set of fitness parameter values on subsequent proposed final routes to converge on a final route. The client can also be configured to store executable code, the executable code being sufficient to enable the client to communicate with the server for purposes of sending requests and receiving responses. It is contemplated that distance can include a function of geographic distance or, e.g., travel time or travel distance, also accounting for current traffic conditions.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a flowchart showing a client-side perspective of embodiments of inventive subject matter.

FIG. 2 is a server-side perspective of embodiments of the inventive subject matter.

FIGS. 3A-3D show an example visualization of the actions undertaken in FIG. 2.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

Also, as used in this application, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be noted that any language directed to a computer should be read to include any suitable combination of computing devices, including servers, interfaces, systems, databases, agents, peers, Engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. The following description includes information that may be useful in understanding the present invention. It is not an admission that any of the information provided in this application is prior art or relevant to the presently claimed invention, or that any publication specifically or implicitly referenced is prior art.

The inventive subject matter relates to systems and methods of developing routes using a set of locations where a user provides the desired locations to the routing system, and the routing system delivers a route to the user. Systems and methods of the inventive subject matter improve efficiency in route development to save users time when visiting all of the locations in a route. This can be useful in many different contexts, including in delivery routes and sales routes where users need to make many different stops along a route and efficiency is important to ensure all deliveries are made or all sales visits are completed.

Contemplated systems and methods allow users to request routes that include any number of locations. Locations can be sent from client to server via, for example, XL upload, CRM migration, or even manual upload, and then systems and methods of the inventive subject matter can geocode, route, and organize the data (e.g., the locations) into clusters. Clusters can then be included in a route that embodies a geographically efficient flow so that users can access and visit as many locations (e.g., sales locations) as possible in a set amount of time. It is also contemplated that finalized routes can be imported and visually represented on any navigation platform (e.g., Waze, Google Maps, Apple Maps, Uber, Lyft, etc.) allowing users to navigate to each location using their preferred platform.

Systems and methods of the inventive subject matter thus automate and improve upon the generation of routes that pass through a set of locations. Users requesting generation of a route can have an option to manipulate the manner their routes and locations are organized and exhibited. Users of a platform implementing the inventive subject matter can select certain locations from a larger route, save multiple routes, change cluster orientation or sequencing or choose to forego the cluster system altogether. Although the examples used in this application relate to, for example, routing for sales representatives, it is contemplated that systems and methods of the inventive subject matter can be implemented in any situation where routing through locations is needed, such as routing delivery routes.

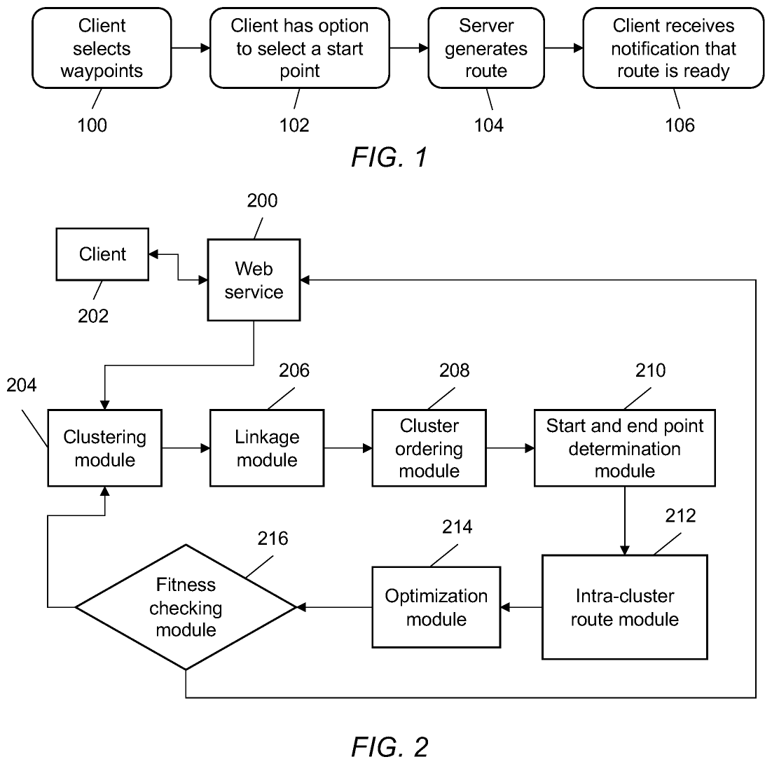

FIG. 1 shows a client-side flowchart, giving insight into how embodiments of the inventive subject matter work from the perspective of the client. In step 100, a user selects locations. The locations that a user selects comprise geolocation information (e.g., latitude and longitude or information that is otherwise sufficient to connect those locations to locations in the real world or on a map). Users can select any number of locations. In some embodiments, 1500 locations is a maximum number that can be incorporated into a route, but this limitation is a programmed limitation to ensure adequate route generation performance given the computational power required to create routes having that many locations. Having more than 1500 can result in undesirable slowdown in route generation using current technologies. Because this limitation is based on computing power, it is contemplated that it can be lifted in the future with either increased computing power or a system and method for enabling existing computing power to efficiently calculate routes having more than 1500 locations, and there is no theoretical limit to how many locations can be used in the route generation process.

Step 102 is an optional step that gives the client an opportunity to select a starting point. A starting point can be, for example, one of the locations that the user would like added to a route. In some embodiments, a starting point can be a current location of the user or a desired start location that is separate from the locations selected by the user for route creation. In embodiments where the start point is does not coincide with a location going into a route, the system can use the start point when determining start and end locations for the route (e.g., a location that is closest to the start point can become the first location of the route). It is contemplated, for purposes of this application, that a determination of closeness, distance, or similar metrics can be based on a distance between two points (e.g., linear or otherwise), distance between two points if a user is in a car, on a bicycle, or on foot and must follow ordinary traffic laws and traffic flows, how long it will take to travel between two points based on current traffic information, etc., or any combination or function of those metrics.

In step 104, the server that receives all of the locations and other information (e.g., start point) from the client then uses that information to develop a route. The route is therefore remotely computed to create a desired path among numerous locations. Embodiments enables efficient computations among a greater number of locations than before on existing hardware, and computing paths remotely saves battery life on mobile devices and enables faster computation through use of more powerful hardware. This process is described below in more detail in relation to FIG. 2. Finally, in step 106, the client receives a notification from the server (e.g., the user) that the route is ready, thereby granting the user access to the route.

FIG. 2 is a flowchart of actions taken on the server side in the course of creating a route, showing all of the different modules that run on a server/server and are handled by the web service. The web service 200 (along with all of the other modules shown in FIG. 2) can be run on one or more servers (e.g., a cloud service or in-house server or servers), and it is configured to receive client messages and to send out responses to those messages. As shown in FIG. 1, a client 202 selects locations and then sends a message to the web service 200, the message comprising the selected locations. In some embodiments, the client's message comprises at least the selected locations, but it can also include a client start point. The client start point can alternatively be included in a separate message, request, or response to a server 200 request.

It is contemplated that the web service 200 is coupled with each of the other modules shown in FIG. 2. Each of the modules can be operated on the same server or servers as the web service, although it is contemplated that modules can be run on any server so long as the modules are enabled to communicate with each other. Locations included in a client's request to a server are first processed by a clustering module 204. The clustering module 204 takes all of the locations and groups them into different clusters.

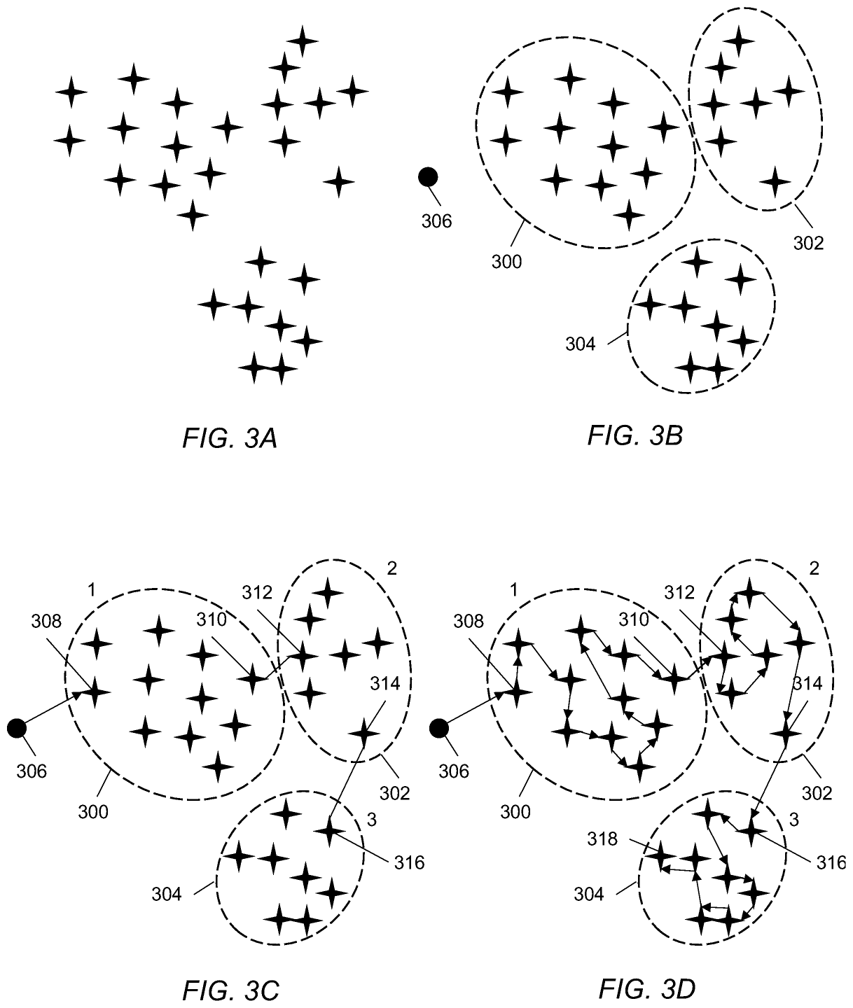

FIGS. 3A-3B show an embodiment of the clustering process, with an optional start point 300 included. Clusters can be created based on proximity (e.g., geographic proximity, time proximity, linear distance, route distance based on mode of transportation, etc.) of the different locations that are passed from a client 202 to a web service 200 when requesting development of a route. FIG. 3A shows a visualization of a set of locations that are sent to the web service 200. Each location, as mentioned above, can include geolocation information (e.g., latitude and longitude, or any other coordinates/information sufficient to link the locations to a real-world location). The clustering module 204 then takes those locations and groups them into one or more clusters. FIG. 3B shows the locations from FIG. 3A organized into three different clusters. A cluster can include one or more locations.

Clusters can be grouped based on distance between locations, where distance between locations can be, for example, a function of distance that determines distance considering various factors such as geographical distance between locations, time to travel between them, or any other description of distance that is included in this application. In some embodiments, cluster grouping can also take into account secondary factors, such as size of client at a location, whether a client at a location is current customer, projected willingness to enter into a new contract, lead rating, etc. As shown in FIG. 3B, three clusters are developed from the locations shown in FIG. 3A. It is not a requirement that each cluster comprise a same or similar number of locations. Instead, distance between locations is used (e.g., either alone or in a function that is used to determine clusters) to group locations into clusters of geographically related locations. Clusters comprising geographically related locations (e.g., locations that are all relatively close to each other based on distance or any function of distance as described in this application) results in clusters comprising locations that are all possible for a user to visit while following a generated route.

Clusters can be created using a variety of different techniques including one, or any combination of, K-means clustering, density-based spatial clustering of applications with noise (DBSCAN), Hierarchical clustering, Expectation maximization clustering, or advanced techniques such as clustering with neural network with standard algorithms as their activation function, Autoencoders, Deep Belief Nets, Hebbian Learning, etc. The clustering technique or techniques that are implemented in embodiments of the inventive subject matter can be determined by, for example, conducting an exploratory analysis. Each clustering technique can have associated input parameters. For example, K-means clustering requires a quantity of clusters as an input, while DBSCAN requires, for example, radius and min_samples (e.g., minimum number of points to define a dense region) as input parameters. Values of input parameters for respective clustering algorithms can have an effect on the resultant clusters. In some embodiments, clustering techniques start with default values for parameters for building the clusters, which an AI system can iteratively optimize.

Once clusters are created, the linkage module 206 takes those clusters and links them together. In some embodiments, one cluster is linked to another according to a shortest distance between two locations belonging to the two different clusters. When there are three or more clusters, linkages exist only between two different clusters, and it is contemplated that clusters can be linked in non-repeating sequences (e.g., cluster one links to cluster two, and cluster two links to cluster three, without ever looping back to link to an earlier cluster). FIG. 3C shows three different clusters 300, 302, & 304 that are linked together to create a chain of clusters.

A goal of linking clusters is to identify a single linkage between each cluster to every other cluster in a group of clusters. A single linkage can be the shortest distance between a location from one cluster to a location point from another cluster. It is contemplated that straight-line distance can be used for the purpose of calculation, but all other measures of distance as described in this application can also be used. E.g., it is also contemplated that a distance metric can be a function of multiple different distance determinations (e.g., a function of travel time, straight-line distance, and current/historical traffic data and trends).

With the clusters linked together, the cluster ordering module 208 determines an order for the clusters. FIG. 3C shows cluster order, with the top left cluster coming first, the top right cluster coming second, and the bottom cluster coming third. Cluster ordering can depend on a variety of factors, including: estimated time to visit all locations in a route in either direction (e.g., where faster estimated route completion times are better) and whether a user has included a start point. When, for example, a user has indicated a starting point, the nearest cluster to that starting point is thus more likely to be the “first” cluster according to the ordering module. In some embodiments, geographic proximity is not as heavily weighted as travel time from the starting point to a location in a cluster, and a location that is farther away from the starting point can nevertheless be the one first visited from a starting point. FIG. 3B shows a starting point 306, which is then linked to cluster 300 as shown in FIG. 3C.

Once a linkage is identified for every cluster with at least one neighboring cluster, each cluster can be considered as a point on the map rather than the actual cluster itself. By doing so, the problem can be reduced to a variant of travelling salesman problem that can be efficiently solved by using, for example, Djkstra's algorithm. To identify an optimized sequence for the clusters (e.g., when the clusters are themselves viewed as points on a map) using, for example, Djkstra's algorithm in conjunction with nearest neighbor search (or any other suitable algorithm or determination process), at least two inputs are required: distance between clusters, which can be determined by calculating the linkages, and a starting cluster. If the optional start point is supplied with sufficient geolocation information such as latitude and longitude, it can be used in determining which cluster should come first in a cluster sequence. In the absence of a client-supplied starting point, any cluster can come first. A variety of algorithms can be used to determine cluster ordering and distance covered from start of a cluster route to end of a cluster route can be determined. A cluster route is a route whereby each cluster is interpreted as a single point on a map for purposes of determining cluster sequence. These steps can be repeated until each cluster has been considered as a possible start point, and each time this process is completed, the resulting cluster route can be compared with all or some subset of all previously evaluated cluster routes. Then, based on which starting cluster results in an optimized cluster route, that cluster can be selected as the first cluster in the cluster sequence. In cases where there are so many clusters as to result in computational challenges in determining cluster routes for all possible cluster starting points, other heuristics, as well as several AI based algorithms, can be implemented to identify an order of the clusters rather than going through all possible combinations. For example, K-D tree optimization, genetic algorithm optimization, ant colony optimization, swarm optimization, etc., are all contemplated.

Next, the start and end point determination module 210 takes over to determine which locations should serve as start points and end points for each cluster. Once cluster sequence is determined, a start point and end point for each cluster can be set. For example, if there are two clusters, the linkage between cluster 1 and 2 is the shortest possible distance between locations in each of the two clusters and thus the location in the first cluster from where the linkage is measured will be the end point of cluster 1, while the location in the second cluster that the linkage connects to is the start point of cluster 2. This calculation can be extended to any number of clusters.

In some instances, a cluster can have a linkage connect to a previous cluster and to a subsequent cluster at the same location within that cluster. In such instances, a cluster's end point can be determined by calculating the second lowest linkage with the next cluster (e.g., by excluding the start point from the end point calculation). By this mechanism, start points and end points of each cluster can be determined without overlap. Note that the end point of a final cluster of a sequence of clusters (e.g., the final location of the entire route) and the start point of first cluster of a sequence of clusters (e.g., the first location of the entire route) can also be determined using, for example, Djkstra's algorithm.

In FIG. 3C, three clusters with a client start point 306 are shown. Thus, the first cluster 300 has a start point 308, which has been determined by its distance or a distance function to the client start point 306. The first cluster also has an end point 310 that is the location from which the linkage from the first cluster to the second cluster begins. Thus, the first cluster 300 has a defined start point 308 and end point 310. The second cluster 302 thus has a start point 312 as determined by where the linkage connects the first cluster 300 to the second cluster 302, and it has an end point 314 where another linkage connects the second cluster 302 to the third cluster 304. The linkage connecting the second cluster 302 to the third cluster 304 couples the end point of the second cluster 314 with the start point of the third cluster 316.

Once clusters are linked together, the intra-cluster route module 212 performs several functions. First, it develops intra-cluster routes for each cluster. To do this, information related to each cluster (e.g., location geolocation information, cluster order and, cluster start and end points) is passed on to the intra-cluster route module 212. The intra-cluster route module then creates intra-cluster routes, which are routes within each cluster that begin at a cluster's start point, and at a cluster's end point, and pass through each of the locations within the cluster. If a cluster does not have a defined start point or end point, then the start or end point can be selected in the course of an intra-route optimization process. For example, if a cluster has no defined start point, but it does have a defined end point, the intra-cluster route for that cluster can be optimized to pass through all locations such that a user traveling that route travels the least possible distance, and once that route is determined, the starting location for that route becomes the cluster's start point. Thus, the intra-cluster route module 212 determines and optimizes intra-cluster routes for each of the clusters based on the information related to each cluster that is passed along to it.

Intra-cluster routes are shown in FIG. 3D. An intra-cluster route for the first cluster 300 begins at a start point 308 and ends at an end point 310, an intra-cluster route for the second cluster 302 begins at a start point 312 and ends at an end point 314, and an intra-cluster route for the third cluster 304 begins at a start point 316 and ends at an end point 318.

Once intra-cluster routes are identified, fitness of the entire route (e.g., the route that passes through all locations of all clusters) can be evaluated based on a variety of fitness parameters. For example, a route can be evaluated as a function of distance traveled from the route's start route point to the route's end point, total distance between the clusters and the total travel time. It is also contemplated that fitness parameters can be added, or different parameters can be weighted differently, depending on their relative importance to route optimization. For example, total distance traveled on a route can be weighted less than total travel time required to complete a route. This can be useful when a route would take longer to complete due to, for example, traffic conditions or speed limits, when compared to a different route that would require traveling a longer distance but would result in shorter travel time.

With a route now fully developed, the optimization module 214 then takes over to optimize the route. Values of fitness parameters related to a particular route can act as a cost function for an AI system built into the fitness checking module 216. An AI system in the fitness checking module can work toward optimizing various clustering parameters by finding optimal (e.g., maximized) values of fitness parameters through an iterative process. An AI system can include, for example, an artificial neural network, genetic algorithms, swarm optimization, etc. Once a solution with the best fitness value(s) is arrived at as a final, optimized solution (e.g., a final route) that solution is then passed along to a user via the web service 200. If a final, optimized solution is not satisfactorily arrived at according to the fitness checking module 216, then the process can iterate through each of the clustering module 204, the linkage module 206, the cluster ordering module 208, the start and end point determination module 210, the intra-cluster route module 212, and the optimization module 214 before again being checked for optimization at the fitness checking module 216.

Fitness parameters are parameters that can showcase efficiency of a solution. For example, in the process of optimizing ordering of three clusters (A, B and C), there are six possible ordering solutions. If we take, for example, the following two solutions [A, B, C] and [B, A, C], a fitness parameter for this can be defined as (1/total distance traveled). If the distance traveled through A-B-C is 100 units and through B-A-C is 90 units, the fitness parameter value of B-A-C would be 1/90 (which is greater than 1/100), and hence it can be inferred that the 2^{nd} solution is the more efficient among the two.

As shown in FIG. 3D, a final solution can begin at a client start point 306, follow intra-cluster routes for each cluster, connect to each subsequent cluster by linkages connecting the clusters together in sequence, and then end at a final location 318 that belongs to the last cluster 304 in the sequence of clusters.

Although the above-described inventive subject matter is presented as a system, it is contemplated that each of the steps undertaken by a server or set of servers can be described as one or more methods.

Thus, specific systems and methods of route optimization have been disclosed. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A system for creating optimized routes comprising:
a server configured to:
receive a route request from a client computing, the route request comprising a set of locations, wherein each location of the set comprises location geolocation information;
group the set of locations into at least a first cluster comprising at least a first location, a second cluster comprising at least a second location and a third location, and a third cluster comprising at least a fourth location;
determine a cluster sequence;
determine a first shortest distance between the first cluster and the second cluster and a second shortest distances between the second cluster and the third cluster;
wherein the first shortest distance comprises the first location and the second location and the second shortest distance comprises third location and the fourth location;
upon determining the first shortest distance and the second shortest distance, determine a first intra-cluster route for the first cluster, a second intra-cluster route for the second cluster, and a third intra-cluster route for the third cluster, wherein the first intra-cluster route ends at the first location, the second intra-cluster route begins at the second location and ends at the third location, and the third intra-cluster route begins at the third location;
determine a starting location for the first intra-cluster route;
assemble the first, second, and third intra-cluster routes, the first shortest distance, and the second shortest distance into a proposed final route;
apply a set of human-defined fitness parameters to the proposed final route to determine a corresponding set of fitness parameter values;
iteratively determine the set of fitness parameter values on subsequent proposed final routes to converge on a final route; and
send, to the client, a route response comprising the final route.

2. The system of claim 1, wherein the server is further configured to receive a start point from the client, the start point comprising geolocation information.

3. The system of claim 2, wherein the first intra-cluster route starts at a location associated with the start point.

4. The system of claim 2, wherein the start location of the client comprises a current client location.

5. The system of claim 2, wherein the start location of the client comprises a desired start location.

6. The system of claim 1, wherein each intra-cluster route connects all locations within each cluster.

7. The system of claim 1, wherein the server is configured to group the set of locations according to DBSCAN.

8. A system for creating optimized routes comprising:
a server configured to:
receive a route request from a client, the route request comprising a set of at least three locations, wherein each of the at least three locations comprises geolocation information, and wherein one of the at least three locations corresponds to a client-designated start point location;
conduct an AI-based clustering process on the set of locations, thereby grouping the set of the at least three locations into a set of clusters comprising at least two clusters, the first cluster comprising a first location and the second cluster comprising a second location and a third location;
determine a cluster sequence based on the client-designated start location;
determine a shortest distance between the first cluster and the second cluster, the shortest distance comprising a distance between the first location and the second location;
upon determining the shortest distance, determine an intra-cluster route for the second cluster;
determine, based on the client-designated start location, a starting location for a proposed final route;
determine the proposed final route based on the client-designated start location, the shortest distance between the first location from the first cluster and the second location from the second cluster, and the intra-cluster route for the second cluster; and
send, to the client, a route response comprising the proposed final route.

9. The system of claim 8, wherein the start location of the client comprises a current client location.

10. The system of claim 8, wherein the start location of the client comprises a desired start location.

11. The system of claim 8, wherein each intra-cluster route connects all locations within each cluster.

12. The system of claim 8, wherein the server is further configured to:
determine a second shortest distance between a third location from the second cluster and a fourth location from a third cluster;
upon determining the second shortest distance, determine a third intra-cluster route for the third cluster; and
assemble into a proposed final route (a) the first, second, and third intra-cluster routes, (b) the shortest distant between the first location and the second location, and (c) the second shortest distance.

13. The system of claim 8, wherein the server is further configured to:
apply a set of human-defined fitness parameters to the proposed final route to determine a corresponding set of fitness parameter values; and
iteratively determine the set of fitness parameter values on subsequent proposed final routes to converge on a final route.

14. The system of claim 8, wherein the client is configured to store executable code, the executable code being sufficient to enable the client to communicate with the server for purposes of sending requests and receiving responses.

15. The system of claim 8, wherein the distance comprises a function of geographic distance.
